(19) United States
(12) Patent Application Publication
(10) Pub. No.: US 2009/0109717 A1
(43) Pub. Date: Apr. 30, 2009

(54) POWER FACTOR CORRECTED CIRCUIT HAVING INTEGRATED COIL

(75) Inventors: Dong Kyun RYU, Jeollabuk-do (KR); Heung Gyoon CHOI, Gyunggi-do (KR); Dmitry BERDNIKOV, Gyunggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 12/035,696

(22) Filed: Feb. 22, 2008

(30) Foreign Application Priority Data
Oct. 31, 2007 (KR) 10-2007-110097

(51) Int. Cl. H02M 7/06

(52) U.S. Cl. 363/126

(57) ABSTRACT

There is provided a power factor corrected circuit having an integrated coil in which a plurality of inductors that have been separately used for circuits are wound around one core. The power factor corrected circuit includes a rectifying unit for rectifying a common AC power supply; a coil unit for controlling the change in electric current of the rectified power supply from the rectifying unit according to the switching operation; and a switching unit for complementarily switching the power supply from the coil unit, wherein the coil unit has a core including first and second coils electrically coupled to each other; and first, second and third legs magnetically coupled to each other, and the first coil is wound around the first leg, the second coil is wound around the second leg, and the third leg is combined with the first and the second leg to form magnetic flux paths, respectively.

### CROSS-REFERENCE TO RELATED APPLICATIONS

This application claims the priority of Korean Patent Application No. 2007-110097 filed on Oct. 31, 2007, in the Korean Intellectual Property Office, the disclosure of which is incorporated herein by reference.

### BACKGROUND OF THE INVENTION

1. Field of the Invention

The present invention relates to a power factor corrected circuit, and more particularly, to a power factor corrected circuit having an integrated coil in which a plurality of inductors that have been separately used for circuits are wound around one core.

2. Description of the Related Art

For the electronic devices that perform various previously set operations, it is essential to use a power supply apparatus for converting a common power supply into a drive power supply that is required for driving the electronic devices.

This power supply apparatus may play roles in removing EMI of a power supply, controlling voltage and electric current, or improving a power factor, as well as supplying a previously set power supply.

Meanwhile, the above-mentioned power factor improving function is applied to the power supply apparatus for the effective use of the power supply, and generally realized using an inductance element and a switch element.

The conventional power factor corrected circuit used in the power supply apparatus uses a plurality of inductance elements electrically coupled respectively to a plurality of switch elements, and therefore a circuit area is increased as much as the increased number of the inductance elements. Accordingly, these problems should be essentially solved to meet requirements of light-weight, thin and small electronic devices.

### SUMMARY OF THE INVENTION

An aspect of the present invention provides a power factor corrected circuit having an integrated coil in which a plurality of coils are wound around one core.

According to an aspect of the present invention, there is provided a power factor corrected circuit having an integrated coil, including a rectifying unit for rectifying a common AC power supply; a coil unit for controlling the change in electric current of the rectified power supply from the rectifying unit according to the switching operation; and a switching unit for complementarily switching the power supply from the coil unit, wherein the coil unit has a core including first and second coils electrically coupled to each other; and first, second and third legs magnetically coupled to each other, and wherein the first coil is wound around the first leg, the second coil is wound around the second leg, and the third leg is combined with the first and the second leg to form magnetic flux paths, respectively.

The switching unit may include a first switch electrically coupled to the first coil to switch a power supply from the first coil; and a second switch electrically coupled to the second coil to switch a power supply from the second coil in a complementary manner to the first switch.

The third leg may be formed between the first leg and the second leg.

The first coil may have the same winding number as the second coil.

The first leg and the second leg may have gaps formed to control inductance of the coil unit.

Also, the coil unit may further include a third coil electrically coupled between the rectifying unit and the first and second coils and wound around the third leg.

The first coil may have the same winding number as the second coil, and the third coil may have a lower winding number than the first coil.

Gaps that control inductance of the coil unit may be formed in the first to third legs.

According to another aspect of the present invention, there is provided a power factor corrected circuit having an integrated coil, including a rectifying unit for rectifying a common AC power supply; a coil unit for controlling the change in electric current of the rectified power supply from the rectifying unit according to the switching operation; and a switching unit for complementarily switching the power supply from the coil unit, wherein the coil unit has a core including first and second coils electrically coupled to each other; and first, second, third and fourth legs magnetically coupled to each other, and wherein the first coil is wound around the first leg, the second coil is wound around the second leg, the third leg is combined with the first leg to form one magnetic flux path, and the fourth leg is combined with the second leg to form another magnetic flux path.

The switching unit may include a first switch electrically coupled to the first coil to switch a power supply from the first coil; and a second switch electrically coupled to the second coil to switch a power supply from the second coil in a complementary manner to the first switch.

The first leg may be formed between the second leg and the third leg, and the second leg may be formed between the first leg and the fourth leg.

The first leg and the second leg may have gaps formed to control inductance of the coil unit.

The first coil may have the same winding number as the second coil.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a power factor corrected circuit according to one exemplary embodiment of the present invention.

FIG. 2 is a block diagram illustrating a power factor corrected circuit according to another exemplary embodiment of the present invention.

FIG. 3 is a block diagram illustrating a power factor corrected circuit according to still another exemplary embodiment of the present invention.

FIG. 4 is a graph of electric current for a conventional power factor corrected circuit.

FIG. 5 is a graph of electric current for the power factor corrected circuit according to the present invention, in relation to power factor corrected circuit as shown in FIG. 2.

### DETAILED DESCRIPTION OF THE PREFERRED EMBODIMENT

Exemplary embodiments of the present invention will now be described in detail with reference to the accompanying drawings.

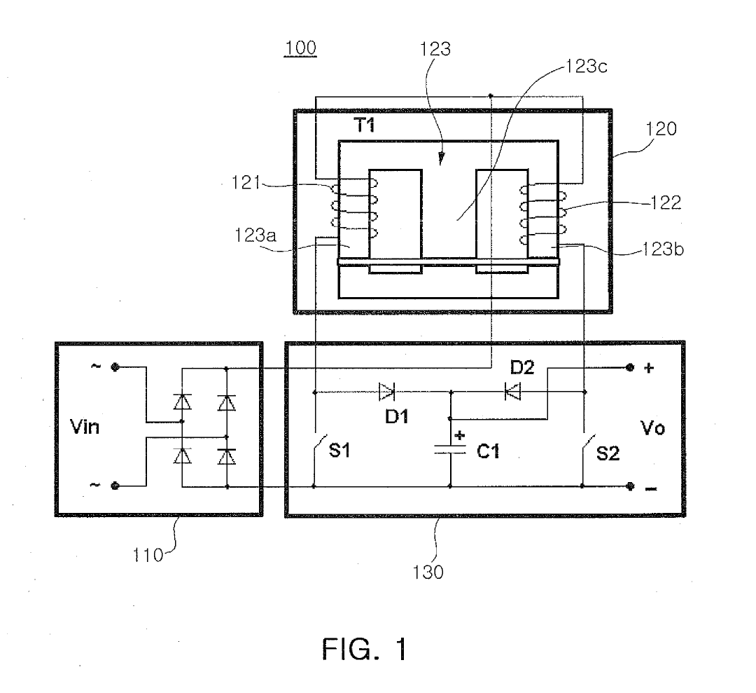

FIG. 1 is a block diagram illustrating a power factor corrected circuit according to one exemplary embodiment of the present invention.

Referring to FIG. 1, the power factor corrected circuit 100 according to one exemplary embodiment of the present invention includes a rectifying unit 110, a coil unit 120 and a switching unit 130.

The rectifying unit 110 may be composed of bridge diodes, and functions to rectify a common AC power supply.

The coil unit 120 may have a first coil 121, a second coil 122 and a core 123, and the first coil 121 and the second coil 122 are electrically coupled respectively to the rectifying unit 110.

The core 123 has first to third legs 123a, 123b and 123c that are magnetically coupled to each other through the coupling of an EE core or an EI core, and the first coil 121 is wound around the first leg 123a and the second coil 122 is wound around the second leg 123b.

The third leg 123c is disposed between the first leg 123a and the second leg 123b, and combined with the first leg 123a and the second leg 123b to form magnetic flux paths, respectively.

Gaps G that control inductance of the coil unit 120 may be formed in the first leg 123a and the second leg 123b around which the first coil 121 and the second coil 122 are wound, respectively, and also may be formed in the third leg 123c which do not consists of any coils.

The switching unit 130 has a first switch S1 for switching a power supply from the coil unit 120; and a second switch S2 for switching a power supply from the coil unit 120 in a complementary manner to the first switch.

In addition, the switching unit 130 may further include first and second diodes D1 and D2 for rectifying a power supply during a switching operation; and a capacitor C1 for stabilizing an output power supply.

The first switch S1 is electrically coupled to the first coil 121, and the second switch S2 is electrically coupled to the second coil 122.

The first switch S1 and the second switch S2 are switched in a complementary manner. A winding direction of second coil 122 can be either straight or opposite to that of first coil 121. The opposite connection is preferably, because can provide higher value of power factor due to compensation effect of current distortions. Also, a winding number of the first coil 121 is preferably identical to that of the second coil 122 to maintain the equilibrium of the excited electric current.

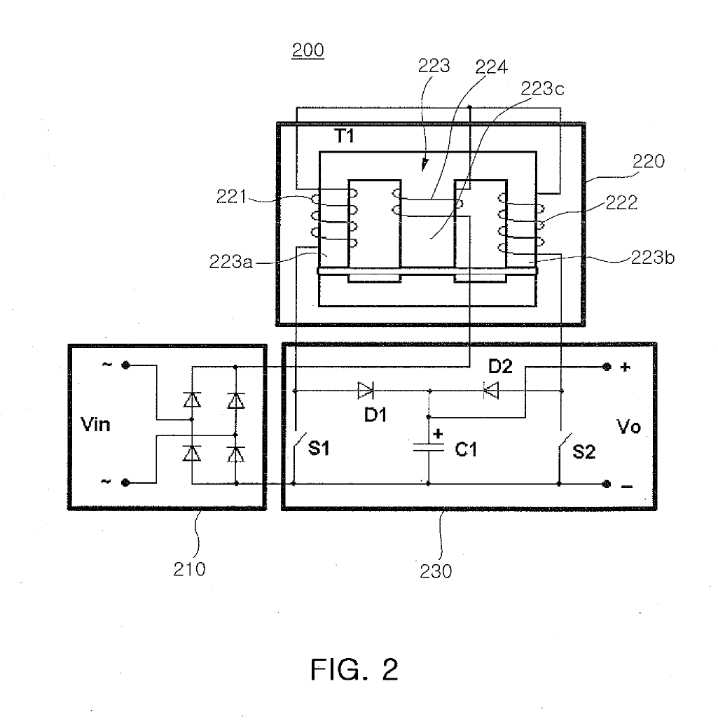

FIG. 2 is a block diagram illustrating a power factor corrected circuit according to another exemplary embodiment of the present invention.

Referring to FIG. 2 together with FIG. 1, the power factor corrected circuit 200 according to another exemplary embodiment of the present invention as shown in FIG. 2 includes the same components, for example a rectifying unit 210 and a switching unit 230, as the power factor corrected circuit 100 according to one exemplary embodiment of the present invention as shown in FIG. 1, and therefore descriptions of the rectifying unit 210 and the switching unit 230 are omitted for clarity.

A coil unit 220 used in the power factor corrected circuit 200 according to another exemplary embodiment of the present invention may include a first coil 221, a second coil 222 and a core 223, and the first coil 221 and the second coil 222 are electrically coupled to the rectifying unit 210, respectively.

The core 223 has first to third legs 223a, 223b and 223c that are magnetically coupled to each other through the coupling of an EE core or an EI core, and the first coil 221 is wound around the first leg 223a and the second coil 222 is wound around the second leg 223b.

The third leg 223c is disposed between the first leg 223a and the second leg 223b, and combined with the first leg 223a and the second leg 223b to form magnetic flux paths, respectively.

Gaps G that control inductance of the coil unit 220 may be formed in the first to third legs 223a, 223b and 223c.

Meanwhile, the coil unit 220 may further include a third coil 224 that is wound around the third leg 223c. Therefore, a gap G that controls inductance of the coil unit 220 may be formed in the third leg 223c, as described above.

It is possible to solve the problem regarding the electric current distortion, which is caused by the overlapping of the excited electric current in the core 223 during a complementary switching operation, by suppressing the change in the electric current when the third coil 224 is electrically coupled between the rectifying unit 210 and the first and second coils 221 and 222 and the first coil 221 has the same winding direction as the second coil 222. Also, a winding number of the first coil 221 is preferably identical to that of the second coil 222 to maintain the equilibrium of the excited electric current. A winding number of the third coil 224 is preferably lower than those of the first and second coils 221 and 222. In addition, a cross-sectional area of the third leg 223c may be identical to the sum of cross-sectional areas of the first leg 223a and the second leg 223b as it is generally used in the standard EE or EI cores.

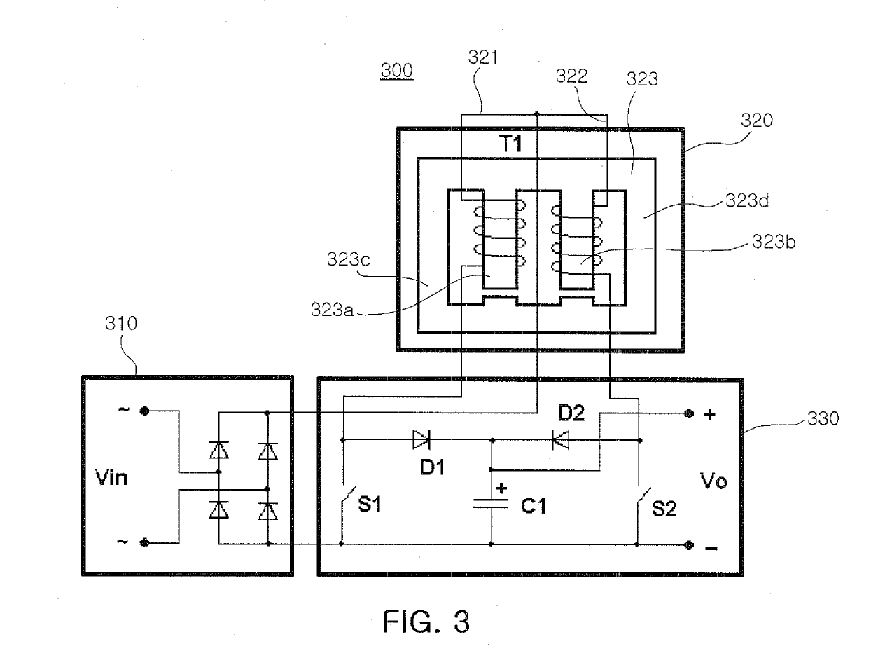

FIG. 3 is a block diagram illustrating a power factor corrected circuit according to still another exemplary embodiment of the present invention.

Referring to FIG. 3 together with FIG. 1, the power factor corrected circuit 300 according to still another exemplary embodiment of the present invention as shown in FIG. 3 includes the same components, for example a rectifying unit 310 and a switching unit 330, as the power factor corrected circuit 100 according to one exemplary embodiment of the present invention as shown in FIG. 1, and therefore descriptions of the rectifying unit 310 and the switching unit 330 are omitted for clarity.

A coil unit 320 used in the power factor corrected circuit 300 according to still another exemplary embodiment of the present invention may include a first coil 321, a second coil 322 and a core 323, and the first coil 321 and the second coil 322 are electrically coupled to the rectifying unit 310, respectively.

The core 323 has a first to fourth legs 323a, 323b, 323c and 323d that are magnetically coupled to each other through the coupling of an EE core or an EI core, and the first coil 321 is wound around the first leg 323a and the second coil 322 is wound around the second leg 323b.

To form legs of the core 323, the first leg 323a and the second leg 323b are formed adjacent to each other, the third leg 323c is formed in the closest proximity to the first leg 323a, and the fourth leg 323d is formed in the closest proximity to the second leg 323b.

Gaps G that control inductance of the coil unit 320 may be formed respectively in the first and second leg 223a and 223b around which the first coil 321 and the second coil 322 are wound, respectively. Therefore, the first leg 323a and the third leg 323c form one magnetic flux path, and the second leg 323c and the fourth leg 323d form another magnetic flux path.

Accordingly, since the magnetic flux paths of the electric current that is excited in the core 323 during the complementary switching operation are different from each other, the magnetic flux paths of the electric current are not overlapped with each other, and therefore the currents of coils flow independently and have the same ratings as one in the separated inductors. A winding direction of the first coil 321 is preferably identical to that of the second coil 322, and a winding number of the first coil 321 is also preferably identical to that of the second coil 322 to maintain the equilibrium of the excited electric current.

Hereinafter, an operation and action of the power factor corrected circuit according to the present invention will be described in detail with reference to the accompanying drawings.

Referring to FIG. 1, an electric current from the rectifying unit 110 is identical to the sum of an electric current flowing in the first coil 121 and an electric current flowing in the second coil 122.

The electric current i1 flowing in the first coil 121 and the electric current i2 flowing in the second coil 122 are calculated as represented by the following Equation 1.

$$( \begin{matrix}i 1 \\ i 2\end{matrix} ) = {( \begin{matrix}w 2 & 0 \\ 0 & w 2\end{matrix} )}^{- 1} \cdot ( \begin{matrix}R 1 + R 2 & - R 2 \\ - R 2 & R 1 + R 2\end{matrix} ) \cdot ( \begin{matrix}Φ 1 \\ Φ 2\end{matrix} ) \qquad Equation 1$$

wherein, W2 independently represents winding numbers of the first and second coils 121 and 122, R1 represents magnetic reluctance of the first and second legs 123a and 123b, R2 represents magnetic reluctance of the third leg 123c, and Φ1 and Φ2 represent fluxes of the first leg 123a and the second leg 123b, respectively.

Next, referring to FIG. 2, an electric current from the rectifying unit 210 is identical to the sum of an electric current flowing in the first coil 221 and an electric current flowing in the second coil 222, and the electric current i1 flowing in the first coil 221 and the electric current i2 flowing in the second coil 222 are calculated as represented by the following Equation 2.

$$( \begin{matrix}i 1 \\ i 2\end{matrix} ) = {( \begin{matrix}w 2 + w 3 & w 3 \\ w 3 & w 2 + w 3\end{matrix} )}^{- 1} \cdot ( \begin{matrix}R 1 + R 2 & R 2 \\ R 2 & R 1 + R 2\end{matrix} ) \cdot ( \begin{matrix}Φ 1 \\ Φ 2\end{matrix} ) \qquad Equation 2$$

wherein, W2 independently represents winding numbers of the first and second coils 221 and 222, W3 represents a winding number of the third coil 224, R1 represents magnetic reluctance of the first and second legs 223a and 223b, R2 represents magnetic reluctance of the third leg 223c, and Φ1 and Φ2 represent fluxes of the first leg 223a and the second leg 223b, respectively. The electric current flowing in the third coil 224 is identical to the sum of the electric current flowing in the first coil 221 and the electric current flowing in the second coil 222, as described above.

Finally, referring to FIG. 3, an electric current from the rectifying unit 310 is identical to the sum of an electric current flowing in the first coil 321 and an electric current flowing in the second coil 322, and the electric current i1 flowing in the first coil 321 and the electric current i2 flowing in the second coil 322 are calculated as represented by the following Equation 3.

$$( \begin{matrix}i 1 \\ i 2\end{matrix} ) = {( \begin{matrix}w 1 & 0 \\ 0 & w 1\end{matrix} )}^{- 1} \cdot ( \begin{matrix}R 1 & 0 \\ 0 & R 1\end{matrix} ) \cdot ( \begin{matrix}Φ 1 \\ Φ 2\end{matrix} ) \qquad Equation 3$$

wherein, W1 independently represents the first and second coils 321 and 322, R1 represents magnetic reluctance of the first and second legs 323a and 323b, and Φ1 and Φ2 represent fluxes of the first leg 323a and the second leg 323b, respectively.

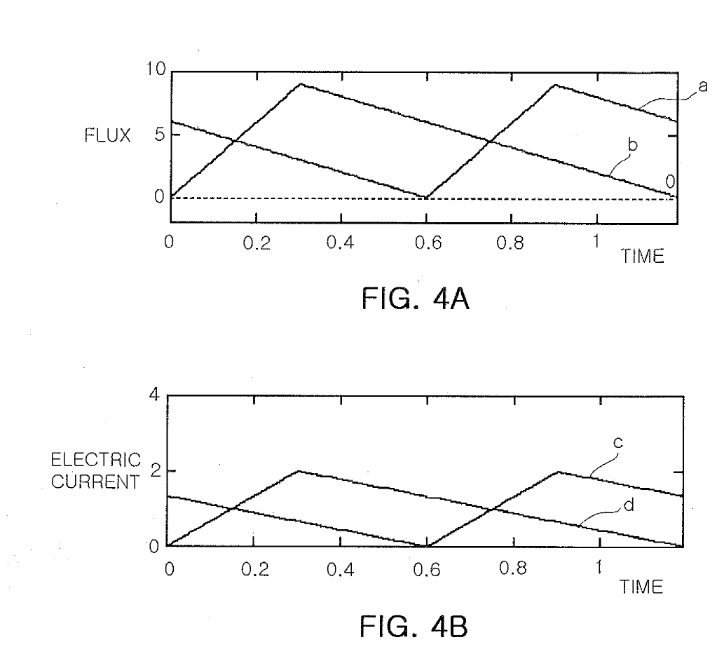

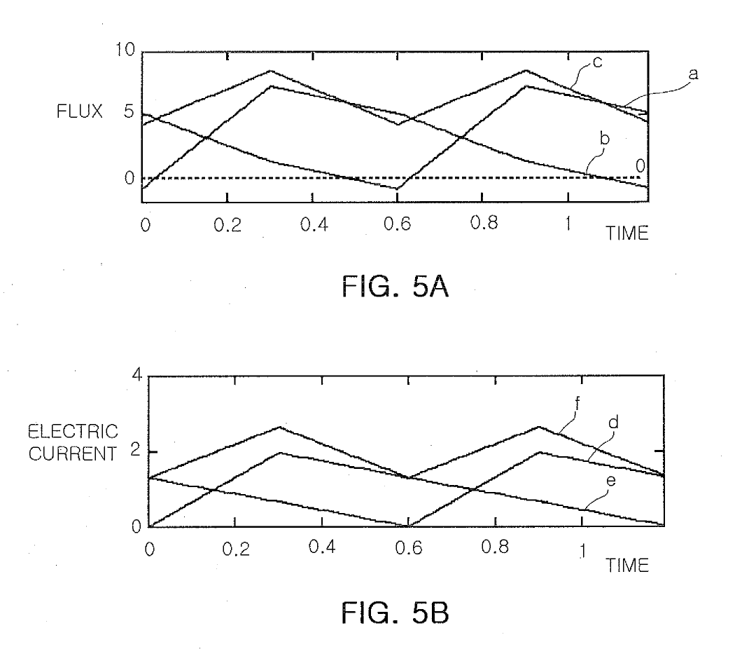

FIG. 4 is a graph of electric current for a conventional power factor corrected circuit, and FIG. 5 is a graph of electric current for the power factor corrected circuit according to the present invention.

Reference numerals “a and b” as shown in FIG. 4 (a) represent fluxes of inductors used respectively in the conventional power factor corrected circuit, and reference numerals “c and d” as shown in FIG. 4 (b) represent electric currents of inductors used respectively in the conventional power factor corrected circuit.

Reference numerals “a, b and c” as shown in FIG. 5 (a) represent fluxes of the coil unit 220 used in the power factor corrected circuit according to another exemplary embodiment of the present invention, and reference numerals “d, e and f” as shown in FIG. 5 (b) represent electric currents of the first to third coils in the coil unit 220 used in the power factor corrected circuit according to another exemplary embodiment of the present invention.

From the comparison of FIG. 4 and FIG. 5, it is revealed that the electric currents of the integrated coil unit 220 according to the present invention are identical to those of the conventional inductor, and the fluxes are similar in both cases. Therefore the integrated coil unit 220 according to the present invention may be useful to have the same electrical function as the conventional respective inductors and reduce an area of the circuit. It needs to be noted that the integrated coil unit 120 (FIG. 1) may provide slightly distorted shape of current in comparison with the integrated coil unit 220. Nevertheless the power factor can keep steel high enough values. Also, the integrated coil unit 320 (FIG. 3) may provide exactly the same waveforms of currents and fluxes as the unit with separated inductors, and therefore keeps the same high value of power factor as the conventional power factor corrected circuit.

The power factor corrected circuit according to the present invention may be useful to have the same electrical function as in the use of a plurality of respective coils by integrating a plurality of coils into one core, and reduce an area of the circuit.

While the present invention has been shown and described in connection with the exemplary embodiments, it will be apparent to those skilled in the art that modifications and variations can be made without departing from the spirit and scope of the invention as defined by the appended claims.

What is claimed is:

1. A power factor corrected circuit having an integrated coil, comprising:
a rectifying unit for rectifying a common AC power supply;
a coil unit for controlling the change in electric current of the rectified power supply from the rectifying unit according to the switching operation; and
a switching unit for complementarily switching the power supply from the coil unit,
wherein the coil unit has a core including first and second coils electrically coupled to each other; and first, second and third legs magnetically coupled to each other, and
wherein the first coil is wound around the first leg, the second coil is wound around the second leg, and the third leg is combined with the first and the second leg to form magnetic flux paths, respectively.

2. The power factor corrected circuit of claim 1, wherein the switching unit comprises:
a first switch electrically coupled to the first coil to switch a power supply from the first coil; and
a second switch electrically coupled to the second coil to switch a power supply from the second coil in a complementary manner to the first switch.

3. The power factor corrected circuit of claim 2, wherein the third leg is formed between the first leg and the second leg.

4. The power factor corrected circuit of claim 3, wherein the first coil has the same winding number as the second coil.

5. The power factor corrected circuit of claim 4, wherein the first leg and the second leg have gaps formed to control inductance of the coil unit.

6. The power factor corrected circuit of claim 2, wherein the coil unit further comprises a third coil electrically coupled between the rectifying unit and the first and second coils and wound around the third leg.

7. The power factor corrected circuit of claim 6, wherein the first coil has the same winding number as the second coil, and
wherein the third coil has a lower winding number than the first coil.

8. The power factor corrected circuit of claim 6, wherein gaps that control inductance of the coil unit are formed in the first to third legs.

9. A power factor corrected circuit having an integrated coil, comprising:
a rectifying unit for rectifying a common AC power supply;
a coil unit for controlling the change in electric current of the rectified power supply from the rectifying unit according to the switching operation; and
a switching unit for complementarily switching the power supply from the coil unit,
wherein the coil unit has a core including first and second coils electrically coupled to each other; and first, second, third and fourth legs magnetically coupled to each other, and
wherein the first coil is wound around the first leg, the second coil is wound around the second leg, the third leg is combined with the first leg to form one magnetic flux path, and the fourth leg is combined with the second leg to form another magnetic flux path.

10. The power factor corrected circuit of claim 9, wherein the switching unit comprises:
a first switch electrically coupled to the first coil to switch a power supply from the first coil; and
a second switch electrically coupled to the second coil to switch a power supply from the second coil in a complementary manner to the first switch.

11. The power factor corrected circuit of claim 9, wherein the first leg is formed between the second leg and the third leg, and the second leg is formed between the first leg and the fourth leg.

12. The power factor corrected circuit of claim 10, wherein the first leg and the second leg have gaps formed to control inductance of the coil unit.

13. The power factor corrected circuit of claim 12, wherein the first coil has the same winding number as the second coil
